(19) United States
(12) Patent Application Publication
(10) Pub. No.: US 2023/0044616 A1
(43) Pub. Date: Feb. 9, 2023

(54) Unified Contactless Kernel System And Method

(71) Applicant: Visa International Service Association, San Francisco, CA (US)

(72) Inventor: Christian Aabye, San Francisco, CA (US)

(73) Assignee: Visa International Service Association, San Francisco, CA (US)

(21) Appl. No.: 17/791,522

(22) PCT Filed: Jan. 6, 2021
(86) PCT No.: PCT/US2021/012339

§ 371 Date: Jul. 7, 2022

Related U.S. Application Data
(60) Provisional application No. 62/958,163, filed on Jan. 7, 2020.

(51) Int. Cl. G06Q 20/32; G06Q 20/40

(52) U.S. Cl. CPC G06Q 20/3278; G06Q 20/4014

(57) ABSTRACT

Embodiments relate to systems, apparatuses, and methods for performing access interactions between a user device and an access device. A method comprises receiving, by an access device with a single universal kernel comprising a plurality of interaction functionalities and a plurality of sub-kernels, data comprising a kernel identifier identifying a requested kernel of a plurality of kernels to perform an interaction. The access device with the single kernel may determine a first sub-kernel of a plurality of sub-kernels corresponding to an interaction functionality based on the kernel identifier. The access device with the single universal kernel may then process the interaction according to the interaction functionality corresponding to the determined sub-kernel.

### CROSS-REFERENCE TO RELATED APPLICATIONS

This application is a PCT application, which claims priority to U.S. Provisional Application No. 62/958,163, filed on Jan. 7, 2020, which is incorporated by reference in its entirety.

### BACKGROUND

Everyday activities and procedures are increasingly digitally implemented and evolving. Activities of the past such as security, verification and transactions have become exponentially more complex and resource intensive when digitized in pursuit of streamlining and simplifying front-end user activities. Actions such as verifying a human’s identity may now comprise dozens or even hundreds of checks and/or communications happening within fractions of a second. As infrastructure for communication and verification evolves, adoption and implementation of new technology formats often lag behind. For example, user and company adoption of growing technologies is faced with many hurdles including new hardware requirements, additional software installations, human distrust and lethargy, and/or cost of upgrading, etc.

Industries involving in security, verification, and secure transactions are often more vulnerable to these inefficient practices. Threats in the digital space often evolve as quickly or faster than the security systems designed to detect and contain them. Methods of user verification and secure transactions occur in many different formats and users are often unable or unwilling to adapt to more electronic systems and procedures, putting companies and consumers at risk. As a result, many legacy versions of access and personal user devices co-exist in almost every industry. One example to solve the multi-variability of security formats was to include, on access and/or verification hardware devices, a number of different software environments or kernels corresponding to the many different new and old security formats commonly in use. This would allow user devices of a particular version or format communicate to the access devices according to a particular standard, even if that format was a deprecated or legacy format. The access devices would then need to instantiate one of a number of different software environments in order to route the communications with the user devices properly.

Multi-kernel verification systems are subject to a number of potential drawbacks. As one example, access devices, anticipating communication with a variable number of legacy and contemporary versions of user devices, must store a separate kernel for each potential data format it may interact with. The bloat of storing multiple kernels, instantiating those kernel from scratch, routing communications, and then exiting and repeating the process for a potentially different kernel subsequently is an inefficient process. Issues with a compromised kernel of the plurality of stored kernels may compromise the entire access device, especially when security and verification are the primary purpose of the access device. Separate testing of each kernel to ensure continued safety is an inefficient and resource intensive task.

Embodiments of the disclosure address this problem and other problems individually and collectively.

### SUMMARY

The following disclosure provides exemplary systems, apparatuses, and methods for conducting secure transactions. Embodiments are related to methods and systems for a unified contactless kernel. Although reference may be made to such secure financial transactions in the examples provided below, embodiments are not so limited. That is, the systems, apparatuses, and methods described herein may be utilized for any suitable purpose. For example, embodiments of the invention may be used for secure identity verification processes, such as ID or keycard swipes. In another example, embodiments of the invention may be used for digital document procurement, retention and transmission according to variable levels of security clearance. In embodiments of the invention, secure transactions may be conducted online or at a point of transaction (e.g., in person at a point of sale).

One embodiment is related to a method comprising: receiving, by an access device with a single universal kernel comprising a plurality of interaction functionalities and a plurality of sub-kernels, from a user device, data comprising a kernel identifier identifying a requested kernel of a plurality of kernels; determining, by the access device with the single universal kernel, a first sub-kernel of a plurality of sub-kernels based on the kernel identifier; and processing, by the access device with the single universal kernel, an interaction according to a first interaction functionality of the plurality of interaction functionalities corresponding to the first sub-kernel.

Another embodiment is related to a method comprising: sending, by a user device to an access device with a single universal kernel comprising a plurality of interaction functionalities and a plurality of sub-kernels, data comprising a kernel identifier identifying a requested kernel of a plurality of kernels, wherein the access device determines a first sub-kernel of the plurality of sub-kernels based on the kernel identifier; responsive to sending the data, receiving by the user device, a request for interaction data; sending, by the user device to the access device with the single universal kernel, the interaction data, the interaction data corresponding to a first interaction functionality of the plurality of interaction functionalities corresponding to the first sub-kernel.

Another embodiment of the invention is directed to a computer programmed to perform either one of or both of the above-noted methods.

Embodiments of the invention include a system that provides the benefit of legacy and modernized secure transaction routing with the use of a single universal kernel. According to some embodiments, an access device comprising a single universal kernel routes verification operations and secure transactions through the single universal kernel to complete an interaction with a user device. Unlike the multi-kernel architectures in use, the single universal kernel architecture will not require selection, instantiation, routing and post-processing of a variable number of kernels, as the single universal kernel may always be in use regardless of the format of user device it is interacting with.

In some embodiments, the single universal kernel comprises one or more sets of legacy functionalities stored therein which allow for communication and interactions with legacy user devices. In various further embodiments, the single universal kernel stores, separately, universal functionalities which allow for communication and interactions with modern/universal user devices.

In a specific embodiment, the user device is a security card and the access device is a security card reader. In this embodiment, the security card reader comprises a universal kernel which may interact with both universal security cards and legacy security cards to process and determine permission status of a holder of the security card.

In another specific embodiment, the user device is a personal identification card, the access device is a personal identification card reader, and the devices interact to cause the sending of data associated with a user of the personal ID card to the user.

In some embodiments, the access device may perform a preliminary interaction with the user device to determine the presence of data on the user device corresponding to kernel version. The data may indicate the version of the kernel which a legacy card was attempting to access on a legacy multi-kernel access device. In some further embodiments, detection of the legacy kernel version data may use the single universal kernel to activate a functionality stored therein corresponding to a facsimile of the kernel environment associated with the kernel version specified in the data. In some further embodiments, it may be determined that the single universal kernel has received data corresponding to a universal tag and may activate the legacy functionalities stored therein.

In some embodiments, the single universal kernel may receive data from the user device in a format recognizable by a legacy kernel to process a secure transaction. In some further embodiments, the single universal kernel may transform, translate, or otherwise convert data of a particular format into another particular format for parsing according to a particular standard. For example, a universal kernel may receive data in a first format, convert the data to a second format, parse the data in the second format, and convert the data back to the first format for further processing.

In a particular embodiment, the single universal kernel may generate a cryptogram or hash of interaction data received from the user device and share the information with a back-end server for verifying the received data. In some further embodiments, a back-end server may send access data back to the access device, in response to receiving the encrypted interaction data, specifying whether the access device should allow or terminate the interaction.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of an access device according to embodiments.

FIG. 3 shows a block diagram of components of an access device memory according to embodiments.

FIG. 4 shows a flow diagram of interaction processing between an access device and a user device according to embodiments.

FIG. 5 shows a flow diagram of interaction processing for selection of a sub-kernel functionality according to embodiments.

FIG. 6 shows a flow diagram for selection of a sub-kernel functionality according to embodiments.

### DETAILED DESCRIPTION

Prior to discussing the figures of the disclosure, some terms can be described in further detail.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. In some embodiments, a user device can include a card, such as a payment card, an access card, etc.

An “access device” may be any suitable device that provides access to a remote system. An access device may also be used for communicating with a coordination computer, a communication network, or any other suitable system. An access device may generally be located in any suitable location, such as at the location of a merchant. An access device may be in any suitable form. Some examples of access devices include POS or point of sale devices (e.g., POS terminals), cellular phones, personal digital assistants (PDAs), personal computers (PCs), tablet PCs, hand-held specialized readers, set-top boxes, electronic cash registers (ECRs), vending machines, automated teller machines (ATMs), virtual cash registers (VCRs), kiosks, security systems, access systems, and the like.

An access device may use any suitable contact or contactless mode of operation to send or receive data from, or associated with, a mobile communication or payment device. For example, access devices can have card readers that can include electrical contacts, radio frequency (RF) antennas, optical scanners, bar code readers, or magnetic stripe readers to interact with portable devices such as payment cards.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be directly related to the account or may be derived from information related to the account. Examples of account information may include an “account identifier” such as a PAN (primary account number or “account number”), a token, a sub-token, a gift card number or code, a prepaid card number or code, a user name, an expiration date, a CVV (card verification value), a dCW (dynamic card verification value), a CW2 (card verification value 2), a CVC3 card verification value, etc, and may be received from a user device as part of an interaction with an access device. An example of a PAN is a 16-digit number, such as “4147 0900 0000 1234”. In some embodiments, credentials may be considered sensitive information.

A “cryptogram” may include a piece of obscured text such as encrypted text. A cryptogram may be formed by encrypting input data with an encryption key such as a symmetric encryption key. In some embodiments, a cryptogram is reversible so that the inputs that are used to form the cryptogram can be obtained using the same symmetric key to perform a decryption process. In some embodiments, if input data is encrypted using a private key of a public/private key pair, the cryptogram may also be a digital signature. A digital signature may be verified with a public key of the public/private key pair. In some embodiments, a cryptogram may include a dCW (dynamic card verification value).

In embodiments of the invention, a cryptogram can be generated in any suitable manner. In some embodiments, the input to the cryptogram can include data elements including an account identifier such as primary account number, and a variable data element such as a counter, a time of day, or interaction value. Such data may be included using an encryption process such as DES, triple DES, or AES using any suitable encryption keys. The encryption keys may also be UDKs or unique derived keys, and may be generated based upon device specific information such as an account number, which may be encrypted using a master derivation key (MDK). The cryptogram can be verified by another computer such a remote computer by either decrypting the cryptogram to and verifying the decrypted contents with other data (e.g., an account number stored on file), or by encrypting other inputs and then comparing the encrypted result to the cryptogram. Additional details regarding cryptogram formation and verification according to some embodiments can be found in U.S. Pat. Publication No. 2013/0226802, which is incorporated by reference in its entirety.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Interaction data” can include data related to and/or recorded during an interaction. In some embodiments, interaction data can be transaction data of the network data. Transaction data can comprise a plurality of data elements with data values. Interaction data can include data from a user device including credentials such as primary account numbers, access tokens (e.g., payment tokens), expiration dates, verification values, digital signatures, and the like. Interaction data could also include data from an access device or other device to facilitate the processing of a transaction. For example, interaction data from an access device may include a terminal ID, an interaction amount, a nonce., a digital signature, etc.

A “resource provider” may be an entity that can provide a resource such as goods, services, information, and/or access. Examples of resource providers includes merchants, data providers, transit agencies, governmental entities, venue and dwelling operators, etc.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCW (dynamic card verification value), a PAN (primary account number or “account number”), a payment token, a user name, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approvaltransaction was approved; Decline -- transaction was not approved; or Call Centerresponse pending more information, merchant must call the toll-free authorization phone number. The authorization response message may also include an authorization code, which may be a code that a credit card issuing bank returns in response to an authorization request message in an electronic message (either directly or through the transaction processing computer) to the merchant’s access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “kernel” can include a core of an operating system or system environment. In some embodiments, a kernel may preform resource allocation, file management, security operations, verification, transaction processing, etc. A kernel can include any suitable functionality to achieve the outcomes described herein. For example, in some embodiments, a kernel can include first payment functionality according to a legacy payment functionality. In some embodiments, a kernel may be a universal kernel stored by an access device which is associated with a universal payment functionality.

A “sub-kernel” can include a subset of a kernel, a piece of a kernel, or a facsimile of a kernel. In some embodiments, a sub-kernel stores environments and/or functionalities of a universal kernel or a legacy kernel. For example, a first sub-kernel of a universal kernel may store a first functionality of a legacy kernel through which the universal kernel route a particular set of subset of data when performing an interaction. In this example, the universal kernel may perform communicative actions with a legacy user device, route a particular subset of data received from the user device through the first sub-kernel to create a new set of data, and forward that new set of data back to the universal kernel where it will be processed. In some embodiments, a sub-kernel comprises a functionality associated with a format for processing data. In some embodiments, a sub-kernel is a representative set of data corresponding to a separate functionality for processing data.

A “universal kernel tag” can include a data item identifying a universal kernel. A universal kernel tag can include any suitable identifier capable of identifying a universal kernel. For example, a universal kernel can be a value of “1,” a string of “universal,” etc.

“Functionality” can include a range of operations that can be run on a computer. A kernel can include functionality. In some embodiments, a kernel can include payment functionality. For example, a universal kernel can include universal payment functionality. In some embodiments, a universal kernel can further include a plurality of payment functionalities, where each payment functionality of the plurality of payment functionalities is associated with former or previous kernels (e.g., legacy kernels). An “interaction functionality” may denote a format and/or range of operations corresponding to an interaction as defined herein. For example, a user device may attempt to perform an interaction with an access device by transferring data to the access device according to a functionality which allows the access device to decipher or process the data. In some embodiments, data received from a user device is designed to be parsed or processed according to a particular interaction functionality which may be different than a primary interaction functionality stored on an access device.

A “kernel identifier” can include a sequence of characters used to identify or refer to a kernel. A kernel identifier can include any suitable identifier capable of identifying a kernel of a plurality of kernels configured to process data associated with the kernel identifier.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD’s Athlon, Duron and/or Opteron; IBM and/or Motorola’s PowerPC; IBM’s and Sony’s Cell processor; Intel’s Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

### I. Systems

Embodiments provide for systems capable of performing methods described herein.

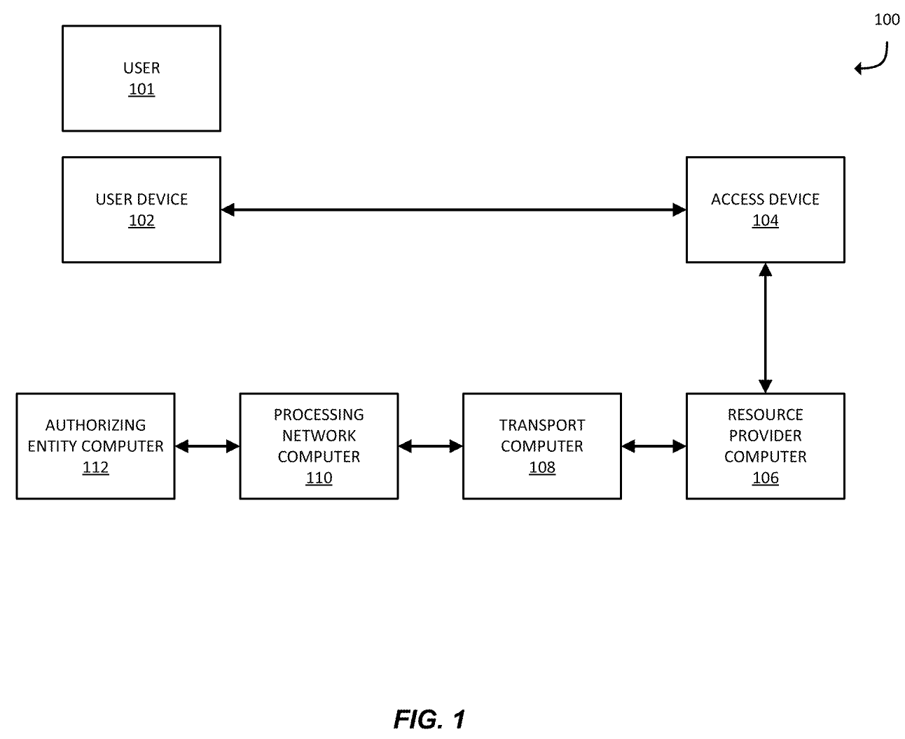

FIG. 1 shows a system 100 according to embodiments of the disclosure. The system 100 comprises a user 101, user device 102, an access device 104, a resource provider computer 106, a transport computer 108, a processing network computer 110, and an authorizing entity computer 112. The user device 102 may be a device which is owned or operated by user 101 and can be in operative communication with the access device 104, which can be in operative communication with the resource provider computer 106. The resource provider computer 106 can be in operative communication with the transport computer 108. The transport computer 108 can be in operative communication with the processing network computer 110. The processing network computer 110 can be in operative communication with the authorizing entity computer 112.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between the devices in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can include any suitable user device described herein. For example, the user device 102 may be an interactive device which user 101 may use to begin an interaction according to the user’s input. The user device 102 can be configured to communicate with the access device 104. For example, once the user 101 specifies that the user device 102 may begin an interaction, the user device 102 may transmit a communication to the access device 104 that allows the user device to receive a command message from the access device 104. The user device 102 may then transmit a response message to the access device 104.

The access device 104 can include any suitable device for providing access to an external computer system. In some embodiments, the access device 104 can include a single kernel (e.g., a universal kernel). The access device 104 may be capable of determining a first payment functionality of a plurality of payment functionalities, which may be used to process an interaction with the user device 102.

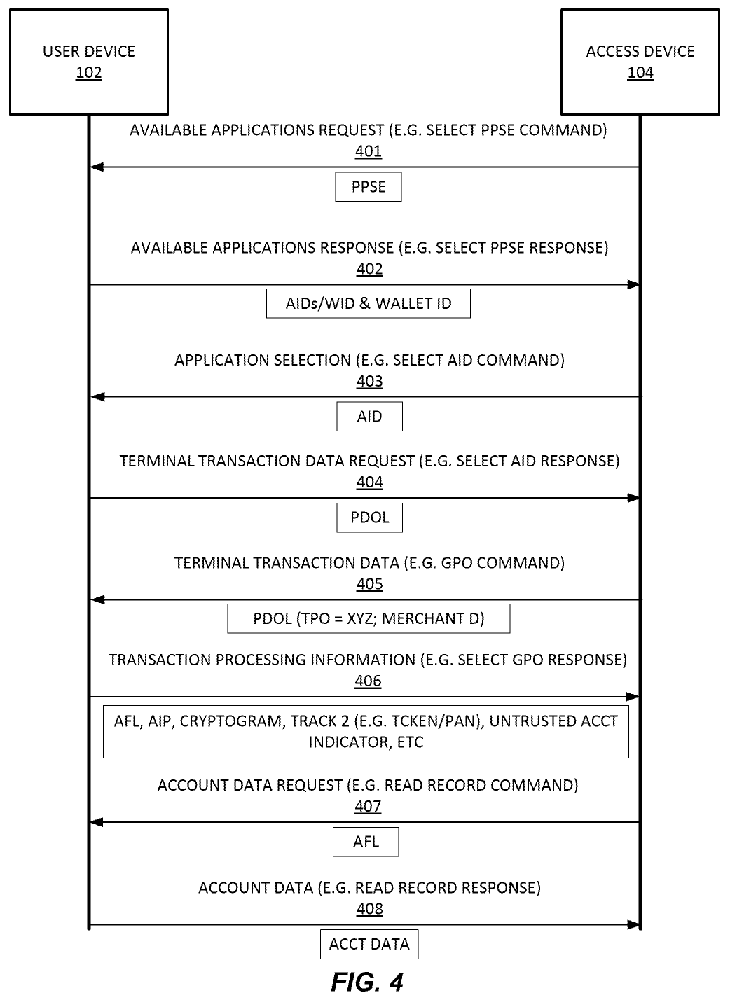

In some embodiments, the access device 104 may transmit and receive one or more messages to and from the user device 102 during an interaction (e.g., as depicted in at least FIG. 4).

In some embodiments, the access device 104 can receive a message, such as an application selection response message, from the user device 102. The message can include a universal kernel tag. The access device 104 can decide to proceed with the interaction, utilizing universal payment functionality within the single kernel based on the universal kernel tag.

In other embodiments, the access device 104 can receive a message comprising a kernel identifier from the user device 102. The kernel identifier can identify a requested kernel of a plurality of kernels. The kernels in the plurality of kernels are potential kernels that could be selected by the user device 102. All kernels in the plurality of kernels would not necessarily reside on the user device 102 or the access device 104. The access device 104 can then determine a first payment functionality of a plurality of payment functionalities based on the kernel identifier. The plurality of payment functionalities can be included in the single kernel. After determining the first payment functionality, the access device 104, with the single kernel, can process the interaction with the first payment functionality.

The resource provider computer 106 can include a computer operated by a resource provider. The resource provider computer 106 may be associated with the access device 104. In some embodiments, the resource provider computer 106 may be associated with a plurality of access devices.

The transport computer 108 be located between (in an operational sense) the resource provider computer 106 and the processing network computer 110. The transport computer 108 may be operated by an entity such as an acquirer. An acquirer can maintain an account of any resource provider with which users may wish to interact.

The processing network computer 110 may route or switch messages between a number of transport computers including the transport computer 108 , and a number of authorizing entity computers including the authorizing entity computer 112. The network computer may be a processing network computer in some embodiments. The processing network computer may be configured to provide authorization services, and clearing and settlement services for payment transactions. A processing network computer may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. Furthermore, the payment processing network may include a server computer and may use any suitable wired or wireless telecommunications network, including the Internet. In some embodiments, the processing network computer may forward an authorization request received from a transport computer to the authorizing entity computer via a communication channel. The processing network computer may further forward an authorization response message received from the authorizing entity computer to the transport computer.

The authorizing entity computer 112 may be configured to authorize any suitable request, including access to data, access to a location, or approval for a payment. In some embodiments, the authorizing entity computer 112 may be operated by an account issuer. Typically, the issuer is an entity (e.g., a bank) that issues and maintains an account of a user. The account may be a credit, debit, prepaid, or any other type of account.

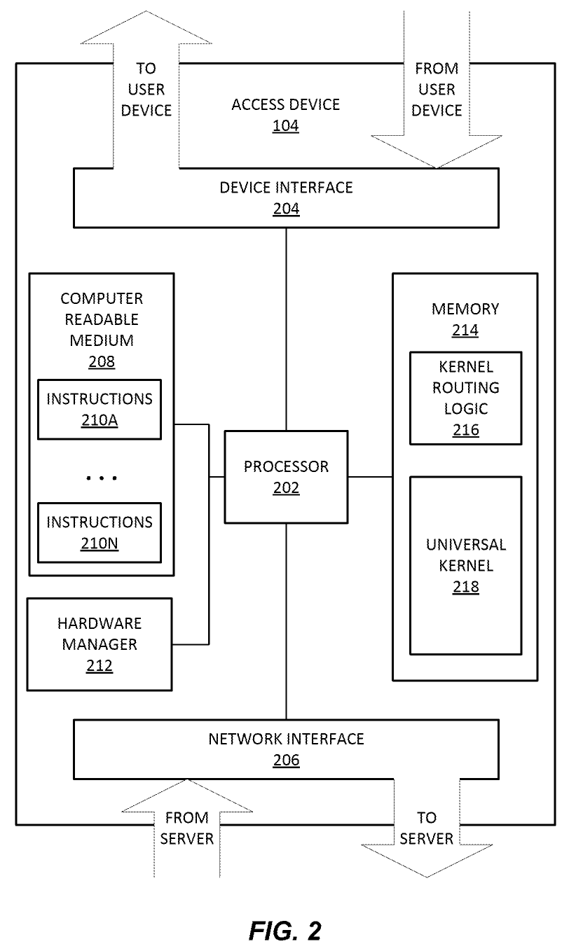

FIG. 2 shows a block diagram of an Error! Reference source not found. 104 according to embodiments. The exemplary access device 104 may comprise a processor 202. The processor 202 may be coupled to a memory 214, a network interface 206, and a computer readable medium 208. The computer readable medium 208 can comprise a number of modules. The processor may also be coupled to a device interface 204 which is capable of sending and receiving data to and from a user device such as user device 102 (e.g., as depicted in at least FIG. 4). The processor may also be coupled to a hardware manager 212 which allows the access device to manipulate and utilize hardware coupled to the access device.

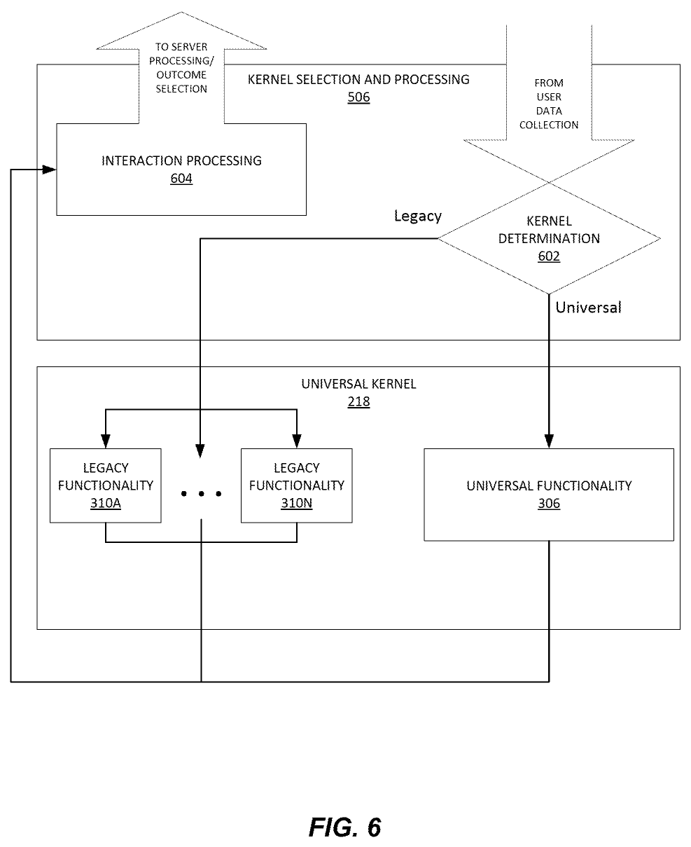

The memory 214 can be used to store data and code necessary to perform the methods and embodiments described herein. The memory 214 may be coupled to the processor 202 internally or externally (e.g., cloud based data storage), and may comprise any combination of volatile and/or non-volatile memory, such as RAM, DRAM, ROM, flash, or any other suitable memory device. For example, the memory 214 can store interaction data and/or any other suitable data described herein. In various embodiments, the memory 214 may comprise kernel routing logic 216 and/or a universal kernel 218. Kernel routing logic 216 may be any series of instructions, modules, steps, or data necessary to determine a kernel or sub-kernel which is relevant to an interaction with a user device. Universal kernel 218 may be a kernel as described herein which comprises one or more functionalities and/or sub-kernels (e.g., as depicted in at least FIG. 6).

The computer readable medium 208 may comprise code or instructions, such as instructions 210A-210N, which are executable by the processor 202, for performing the methods and embodiments described herein. For example, the computer readable medium 208 may comprise different instructions which are executable by the processor to perform different routing functions for different received data from the user device 102. As a possible example, instructions 210A may be instructions for routing interaction data when a user device has requested a kernel tagged as “Kernel A,” and so forth.

The network interface 206 may include an interface that can allow the access device 104 to communicate with external computers. The network interface 206 may enable the access device 104 to communicate data to and from another device (e.g., a user device, a resource provider computer, etc.). As an example, the network interface depicted in FIG. 2 allows the access device to communicate with a server, which may be resource provider computer 106 or any other networked device. Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

Embodiments can use the systems and apparatuses described herein to at least process an interaction with a single kernel, among other processes described herein. The single kernel is a universal kernel, but may process interactions and interaction data from a user device or some other device according to separate kernel functionalities.

Embodiments provide for systems and methods which support implementation of a unified contactless kernel that can have a single kernel. An access device can comprise the single kernel. Processing within the universal kernel can follow any suitable number of paths. For example, there may be 7 paths of processing functionalities, as shown below:
1) Universal kernel functionality
2) Subset of C-2 functionality
3) Subset of C-3 functionality
4) Subset of C-4 functionality
5) Subset of C-5 functionality
6) Subset of C-6 functionality
7) Subset of C-7 functionality

The universal kernel functionality (e.g., path 1) can support the features utilized for user devices with universal functionality. For example, the user devices can include newer EMV (Europay, MasterCard, Visa) cards. In some embodiments, the user devices may include a similar functionality to second generation user devices, and in some cases, without contact features.

Subset of C-x functionalities (e.g., paths 2-7) can be payment functionalities of a plurality of payment functionalities associated with legacy kernels designed to interact with multi-kernel legacy access devices. For example, the universal kernel can include a first payment functionality corresponding to the universal functionality, a second payment functionality corresponding to a first legacy functionality, a third payment functionality, an Nth payment functionality, etc. For example, the first payment functionality corresponding to the universal kernel functionality may support only what is strictly necessary to process interactions with universal user device. The second through Nth payment functionalities may comprises data that is necessary to be backward compatible with corresponding legacy user devices. This hardware configuration is beneficial as it avoids replication of functions between the payment functionalities of the plurality of payment functionalities as well as avoids making the universal kernel too complex and difficult to code and maintain as processes are updated.

A new indicator (e.g., a universal kernel tag) can be received by an access device from the user device (e.g., a card). The access device can receive the universal kernel tag in any suitable message, for example, in a Select AID response. The universal kernel tag can indicate whether or not the user device supports path 1 (e.g., the universal payment functionality (also referred to as universal kernel functionality).

Previous or legacy user devices may not comprise, or have stored in memory, the universal kernel tag. In some embodiments, the lack of a universal kernel tag can indicate to the access device that the user device is a legacy user device. An access device with a single kernel interacting with a legacy user device may then determine a first payment functionality of the plurality of payment functionalities based on a kernel identifier included in the message (e.g., the Select AID response) and/or based on a selected application included in the Select AID response. The first payment functionality may be based on the kernel identifier may correspond to one of the paths 2-7 described above.

In some embodiments, a legacy access device comprising one or more legacy kernels may not recognize a received universal kernel tag. In this case, the universal tag may be configured such that the legacy access device can treat the universal user device supporting the universal kernel as a legacy user device because the access device does not have data stored indicating how a universal kernel tag is utilized. It may be up to a payment system to ensure that such a new application can support the necessary legacy functionality.

In other embodiments, a Select PPSE (proximity payment system environment) and Select AID (application identifier) may be handled by the universal kernel and, in some embodiments, may be coded according to requirements from all 7 paths. Once a Select AID response is received by the access device from the user device, the universal kernel of the access device may 1) examine the Select AID response. For example, if the universal kernel tag for universal kernel functionality is present (e.g., the user device is coded in regards to universal kernel functionality), the access device may perform path 1, above. If the universal kernel tag is not present, then the access device may determine that a legacy user device is presented and that the AID and/or Kernel Identifier can be used to identify which path to execute (e.g., which payment functionality of a plurality of payment functionalities). The access device may then 2) perform the appropriate payment functionality (e.g., subset for the specific path - 2 thru 7). Then the access device may perform a conclusion of the interaction, which may be handled by the universal functionality of the universal kernel.

Next, functionality on an Entry Point kernel (e.g., where the universal kernel is kernel 8), will be described. Entry Point may change such that upon receiving data from the user device, at the access device, kernel 8 may be selected, even if AID or Kernel Identifier points to kernel 2 thru 7. As an example, the Select PPSE and Select AID may be handled by Entry Point on the access device. Once processing has proceeded to Kernel 8 (e.g., the universal kernel), the universal kernel of the access device can 1) examine the Select AID response. For example, if the universal kernel tag for universal kernel functionality is present then the access device can utilize universal payment functionality. If the universal kernel tag is not present, then the access device can determine that a legacy user device (e.g., former user device) is present and that the AID or the kernel identifier can be used to identify the payment functionality. The access device can 2) perform the appropriate payment functionality. The access device can then conclude the transaction, for example, per Entry Point specifications.

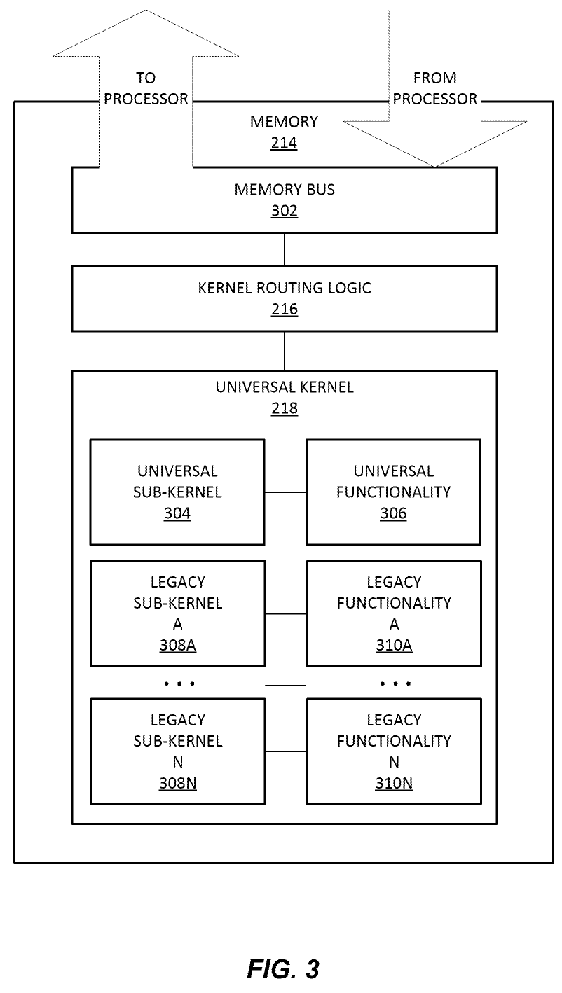

FIG. 3 shows a block diagram of components of an access device memory according to embodiments.

As an example, FIG. 3 shows an exemplary block diagram of the composition of memory 214. As depicted in FIG. 3, memory 214 comprises memory bus 302. Memory bus 302 may be any memory or communication entity which allows access to the memory 214 and may allow communication between the memory 214 and another portion of access device 112. For example, memory bus 302 may allow communication between the memory 214 and the processor 202.

Memory 214 may comprise kernel routing logic 216. Kernel routing logic may be a set of instructions or steps which access device 104 may use to determine which functionality of a plurality of functionalities will be used during an interaction with a user device. Kernel routing logic 216 may be coupled to memory bus 302 to communicate with other portions of access device 102 to determine a functionality. Memory 214 may also comprise universal kernel 218. Universal kernel 218 may be an entity which stores and/or routes data comprising the functionalities determined by kernel routing logic 216. Universal kernel 218 may comprise a number of sub-kernels and/or functionalities. For example, as depicted in FIG. 3, universal kernel 218 comprises universal sub-kernel 304 which is associated with universal functionality 306. Similarity, universal kernel 218 comprises legacy sub-kernels A through N 308A-N each corresponding to legacy functionalities A through N 310A-N. In some embodiments, the functionalities are contained within the corresponding sub-kernels instead of separately within universal kernel 218.

FIG. 4 shows a flow diagram of interaction processing between an access device and a user device according to embodiments. At step 401, a contactless reader of the access device 104 may be configured to identify the presence of a user device 102 within communication range. For example, a contactless interface of the user device 102 may ping or otherwise attempt to find suitable devices to communicate with periodically. When the access device 104 detects the presence of user device 102 in proximity to a contactless reader of the access device 104, for example, an application selection module of the access device 104 may initiate an interaction (e.g., a transaction) by sending a request for available account applets to the user device 102. The request for available applets is sent in order to obtain information regarding which mobile applications and corresponding account applets (e.g., a list of account applet identifiers) may be available on the user device 102. In some embodiments, the request for available applets 201 may be in the form of a “select proximity payment system environment (PPSE)” command. In such embodiments, the request for available applets 201 may include a payment environment identifier (e.g., a PPSE name such as “2PAY.SYS.DDF01”) to identify the payment environment supported by the access device 104.

At step 402, upon receiving the available applications request 401, the user device 102 may identify and process the request by recognizing the payment environment identifier (e.g., PPSE name) included in the request, and respond by sending an available applications response 402 back to access device 104. For example, the available applications response 402 may include a list of available account applet identifiers (AIDs), a wallet identifier associated with a mobile application, application configuration options associated with the available AIDs, and/or may include the proximity payment environment identifier (e.g., PPSE name) as the dedicated file name.

In some embodiments, the available applications response 402 may be in the form of a “select PPSE” response and may include PPSE file control information (FCI). For example, the available applications response 402 may include a directory entry for each available AID on the user device 102 with a wallet identifier associated with each available AID. Each directory entry may include information such as the AID, an application label associated with the AID (e.g., a mnemonic associated with the AID), a wallet identifier (WID) associated with the mobile application, an application priority indicator indicating the priority of the AID, a kernel identifier indicating the application’s kernel preference, and/or additional information relating to the particular AID. The available applications response 402 may also include other data such as FCI issuer discretionary data or any other relevant information.

At step 403, the access device 104 may determine a supported account applet based on the received available applet identifiers and may send an “application selection” command 403 including the selected AID to the user device 102.

Additionally, in some embodiments, upon receiving the application selection message 403, at step 404, the user device 102 may send a terminal transaction data request 404 to request transaction data from access device 104 which may be needed to execute the transaction using the selected application associated with the selected AID. In some embodiments, the terminal transaction data request 404 may be in the form of a “Select AID Response” and may include applet identifier (AID) file control information (FCI) with the selected AID as the dedicated file name. The terminal transaction data request may include a list of transaction data identifiers to request the appropriate data from the access device 104, and the list of transaction data identifiers can be in the form of a processing options data object list (PDOL).

In some embodiments, the user device 102, at step 404, may transmit a message comprising a universal kernel tag to the access device 104. In other embodiments, the message may comprise a kernel identifier. In yet other embodiments, the message may comprise both a universal kernel tag and a kernel identifier.

The transaction data requested by, for example, the mobile application for the transaction may include an entity identifier associated with the access device 104 (e.g., a merchant identifier (MID)), terminal processing options (TPO), authorized amount, other amount, terminal country code, terminal verification results, transaction currency code, transaction data, transaction type, and/or an unpredictable number. The terminal transaction data request may also include other data such as FCI issuer discretionary data, application program identifier, and language preference. In other embodiments, the transaction information may be provided as part of the application selection message 403 and/or as part of the available applications request message 201.

At step 405, after receiving the terminal transaction data request 404, the access device 104 may send, to the user device 102, the terminal transaction data 405 requested by the mobile application. In some embodiments, the terminal transaction data 405 may be sent in the form of a get processing options (GPO) command, and may include the requested terminal transaction data 405 in a processing options data object list (PDOL). In some embodiments, the terminal transaction data 405 (e.g., Transaction Processing Options (TPO)) may include a TPO indicator that indicates which transaction data types the access device 104 supports.

In some embodiments, because the mobile application adds account data without validating the account with an account issuer, different security levels of transactions (e.g., card present (CP) transaction, card-not present (CNP) transaction, advanced authentication (e.g., 3DS Verification) transaction, etc.) may be provided based on the mobile application owner/developer, the merchant, and the status of the selected account applet provisioned on the user device 102. For example, depending on the type of credentials selected, different security levels for the transaction may exist. So, if a validated or trusted account applet is selected, the mobile application may initiate a card present (CP) transaction. However, if non-validated or untrusted accounts are being used, the mobile application may initiate a card-not-present (CNP) transaction. Further, where supported by a merchant POS, the mobile application may initiate a transaction using an enhanced authentication (e.g., 3D-Secure) transaction payload. Accordingly, the TPO (also referred to as access device configuration options) allow the user device 102 to determine whether the access device 104 is configured to process the type of transaction that is associated with the selected account applet.

At step 406, once the selected applet of the user device 102 receives the terminal transaction data 405, the user device 102 obtains the relevant account credentials from the selected applet as well as any other relevant payment information and may send a set of transaction processing information 406 including the account credentials and any other relevant transaction processing information to the access device 104. In some embodiments, the transaction processing information 406 can be sent in the form of a “get processing options” (GPO) response. In some embodiments, the transaction processing information may include one or more application file locators (AFLs) that can be used as file addresses by access device 104 to read account data stored on the user device 102, and an application interchange profile (AIP) that can be used to indicate the capabilities of the payment application.

For example, the transaction processing information may include any credentials for the transaction including a transaction cryptogram generated using transaction information, Track-2 equivalent data, and additional data. For example, the transaction processing information may include an untrusted applet indicator where the transaction is originated using an untrusted account applet. Further, the transaction processing information may include issuer application data (IAD), a form factor indicator (FFI), card transaction qualifiers (CTQ), cryptogram information data (CID), an application transaction counter (ATC), and/or an application PAN sequence number (PSN). In some embodiments, the issuer application data (IAD) may include a length indicator indicating the length of the IAD, cryptogram version number (CVN) indicating the version of the transaction cryptogram, a derived key indicator (DKI) that can be used to identify a master key (e.g. a master key associated with the issuer), and/or card verification results (CVR).

It should be understood that in some embodiments, the transaction processing information 406 being sent from user device 102 to access device 104 may include some or all of the information describe above, and in some embodiments, may include additional information not specifically described.

At step 407, after the access device 104 receives the transaction processing information 406, the access device 104 may send an account data request 407 to the user device 102 to read additional account data 408 that may be stored on the user device 102. In some embodiments, the account data request 407 may be in the form of a “read record” command, and may include an application file locator (AFL) indicating the location of the account data that access device 104 is attempting to read. The AFL included in the account data request 407 may correspond to an AFL in the transaction processing information 406 that was provided to access device 104 from user device 102.

At step 408, in response to receiving the account data request 407 from the access device 104, the user device 102 may send the account data 408 stored at the location indicated by the AFL to access device 104. In some embodiments, the account data 408 may be sent in the form of a “read record” response. The account data 408 may include, for example, application usage control that indicates the issuer’s restrictions on the usage and services allowed for the application, the cardholder’s name, customer exclusive data, issuer country code, and/or other account related data that is accessible at the AFL location and is stored in the user device 102.

It should be understood that in some embodiments, the account data 408 being sent from user device 102 to access device 104 may include some or all of the information describe above, and in some embodiments, may include additional information not specifically described. Further, any and all of this information may be provided in response to receiving a selection message and/or obtaining payment credentials.

In various embodiments not depicted in FIG. 4, the access device with a single kernel 104 can receive a message comprising a universal kernel tag from a user device 102 during an interaction. After receiving the message from the user device 102, the access device 104 can determine to proceed with the interaction utilizing universal payment functionality within the single kernel based on the universal kernel tag. For example, the access device 104 can determine that the universal kernel tag indicates the compatibility between the user device and the universal payment functionality. The access device with the single kernel 104 can the subsequently process the interaction with the universal payment functionality.

In some embodiments, the access device 102 can generate an authorization request message and then provide the authorization request message to a resource provider computer 106 associated with the access device 102. The resource provider computer 106 can provide the authorization request message to a transport computer 108 that can provide the authorization request message to a network processing computer 110. The network processing computer 110 can provide the authorization request message to an authorizing entity computer 112. The authorizing entity computer 112 can determine whether or not to authorize the interaction between, for example, the user 101 of the user device 102 and a resource provider of the resource provider computer 106 associated with the access device 104. The authorizing entity computer 112 can generate an authorization response message comprising an indication of whether or not the interaction is authorized.

The authorizing entity computer 112 can provide the authorization response message to the resource provider computer 106 via the network processing computer 110 and the transport computer 108. In some embodiments, the resource provider computer 106 can provide the authorization response message to the access device 104 which can provide the user device 102 with the indication of whether or not the interaction is authorized. In other embodiments, the resource provider computer 106 can provide the indication of whether or not the interaction is authorized to the user 101 of the user device and/or the user device 102 itself.

In another embodiment not depicted in FIG. 4, an access device with a single kernel 104 can receive a message comprising a kernel identifier identifying a requested kernel of a plurality of kernels. The plurality of kernels are possible kernels that may be present on the access device. For example, a plurality of kernels may include kernels associated with network A, network B, and network C, but only kernels for networks A and B may be on the access device. The requested kernel in an example may be for network A.

The access device can receive the message from a user device 102 during an interaction. In some embodiments, the kernel identifier can be a single digit indicating to the access device 104 which kernel of the plurality of kernels comprises payment functionality capable of processing data in conjunction with the user device. The access device with the single kernel 104 can then determine a first payment functionality of a plurality of payment functionalities based on the kernel identifier. The plurality of payment functionalities can be included in the single kernel (e.g., a universal kernel stored on the access device 104). In some embodiments, wherein each payment functionality of the plurality of payment functionalities are associated with a former kernel. After determining the first payment functionality based on the kernel identifier, the access device 104 can process the interaction with the first payment functionality.

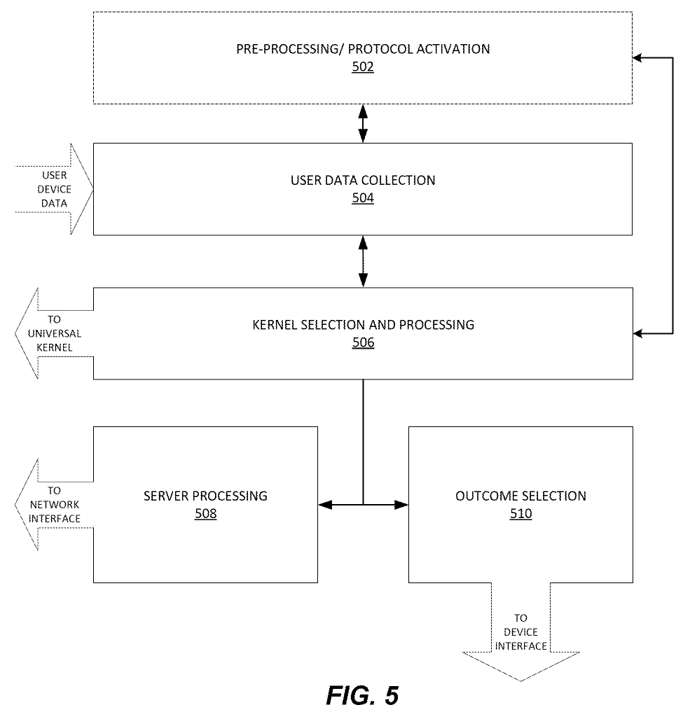

FIG. 5 shows a flow diagram of interaction processing for selection of a sub-kernel functionality according to embodiments. In some embodiments, FIG. 5 comprises logical blocks and entities which reside within kernel routing logic 216. For example, the blocks depicted in FIG. 5 may correspond to a series of steps or entities which carry out a process of selecting a functionality of a plurality of functionalities when processing an interaction between a user device and an access device. Pre-processing/protocol activation block 502 may represent any prior processing or determination made when determining which functionality to apply to an interaction. For example, pre-processing may comprise loading a list of available functionalities on an access device, preparing a payment transaction that is known to be a variable amount, accessing the location site of a security card reader, or any other steps which would aid in pre-processing a kernel selection determination.

User data collection 504 represents any step or entity which will collect user data for use in processing the kernel selection process. For example, user device data collected from a user device by the access device may be routed to user data collection entity 504 for processing the kernel selection. Kernel selection and processing block 506 may be a step or entity which selects a kernel, sub-kernel, or functionality for data processing as part of an interaction (as depicted in FIG. 6). Kernel selection model is coupled to server processing 508 and outcome selection 510. The server processing block 508 depicted in FIG. 5 represents steps or entities which will forward the results of kernel selection or processing to a networked entity. For example, server processing 508 may connect to network interface 206 of access device 104 to route interaction data to an entity such as resource provider computer 106.

Outcome selection 510 may be a step or entity which connects the results of processing the user data through a selected functionality to a future interaction between the access device and the user device. For example, outcome selection 510 may determine the authenticity of data received from a user device and cause the access device to continue or terminal the connection between the user device and access device accordingly. Examples of outcomes include terminating instructions executed by the access device, re-trying an interaction between the devices, approving/declining an interaction, selecting a new functionality not previously determined, and/or requesting additional user information, such as a separate PIN number.

FIG. 6 shows a flow diagram for selection of a sub-kernel functionality according to embodiments. As depicted in FIG. 6, kernel selection and processing 506 comprises the step of kernel determination 602 in using user data received from user data collection entity 504. For example, the determination may be made that, based on a tag or other data received from a user device, the user device is requested the universal kernel. Kernel determination 602 may the route the user information through universal functionality 306 in the universal kernel 218. Alternatively, the tag or other data may indicate a user device request of a legacy kernel. The determination may then route the user data through any of legacy functionalities 310A-310N. Once the user device data has been routed through these functionalities, the resulting data may be returned to interaction processing 604 of the kernel selection and processing entity 506. This information may then be passed on to server processing 508 and/or outcome selection 510 to complete the interaction between the user device and the access device.

The systems, apparatuses, and methods described herein have a number of advantages including improvement of electronic hardware and efficient performance of hardware-implemented tasks. Embodiments provide for an access device which may comprise a single kernel (e.g., the universal kernel) when performing a variety of access interactions and decisions. The consolidation of universal and legacy kernel functionalities onto an access device in a single kernel environment provides improved and consistent data routing functionalities while reducing hardware and software bloat. As one example, access devices utilizing a single universal kernel may route access interactions through the single kernel in an always-on configuration, as opposed to selection and activation of one of a plurality of dormant processing environment kernels in reaction to querying the access device. In another example, kernel consistency testing, maintenance and environment loading times are completed with more efficient resource expenditure due to the implementation of single kernel functionality in lieu of legacy multi-kernel hardware configurations.

Embodiments provide for efficient data processing of data received from user devices in addition to access devices. As one example, the implementation of a universal kernel on access devices enables the functionalities of both universal user devices and legacy user devices on a single hardware environment, preventing costly and resource intensive upgrades. In another example, interaction and functionality of user devices are made more efficient by the improved functionalities of the access device as each device sends and receives data during an interaction. In another example, user devices utilizing universal functionality may operate according to legacy functionalities in the event of a software or hardware failure at the user device which compromises the universal functionality, such as a failed upgrade or faulty signal processor.

Embodiments of the invention may utilize a computer system that may be used to implement any of the entities or components described above. The subsystems in the computer system may be interconnected via one or more system buses. Additional subsystems include a printer, keyboard, fixed disk, and monitor, which is coupled to display adapter. Peripherals and input/output (I/O) devices, which couple to I/O controller, can be connected to the computer system by any number of means known in the art, such as a serial port or Universal Serial Bus (USB) port. For example, serial port or external interface can be used to connect the computer apparatus to a network (e.g., wide area network, local area network, etc.) such as the Internet, a mouse input device, touchscreen, or a scanner. The interconnection via system bus allows the one or more processors to communicate with each subsystem and to control the execution of instructions from system memory or the fixed disk, as well as the exchange of data between subsystems.

The system memory and/or the fixed disk may embody a non-transitory computer-readable storage medium. The non-transitory computer-readable storage medium may store instructions that, when executed by the one or more processors, cause the computer system to implement the methods and flows described herein. Storage media and computer-readable media for containing code, or portions of code, can include any appropriate media known or used in the art, including storage media and communication media, such as but not limited to volatile and non-volatile, removable and non-removable media implemented in any method or technology for storage and/or transmission of data such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired data and which can be accessed by the computer. Based on the disclosure and teachings provided herein, a person of ordinary skill in the art will appreciate other ways and/or methods to implement the various embodiments.

Although the steps in the flowcharts and process flows described above are illustrated or described in a specific order, it is understood that embodiments of the invention may include methods that have the steps in different orders. In addition, steps may be omitted or added and may still be within embodiments of the invention. It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices and may reside on or within a single computational apparatus, and may be present on or within different computational apparatuses within a system or network

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by an access device with a single universal kernel comprising a plurality of interaction functionalities and a plurality of sub-kernels, from a user device, data comprising a kernel identifier identifying a requested kernel of a plurality of kernels;
determining, by the access device with the single universal kernel, a first sub-kernel of the plurality of sub-kernels based on the kernel identifier; and
processing, by the access device with the single universal kernel, an interaction according to a first interaction functionality of the plurality of interaction functionalities corresponding to the first sub-kernel.

2. The method of claim 1, wherein the user device is a security card, the access device is a security card reader.

3. The method of claim 1, wherein the user device is a personal identification card, the access device is a personal identification card reader, and the method further comprises sending, to the user device, data associated with a user of the user device.

4. The method of claim 1, wherein the requested kernel is the single universal kernel, the first sub-kernel of the plurality of sub-kernels is a universal sub-kernel, and the first interaction functionality is a universal functionality corresponding to the universal sub-kernel.

5. The method of claim 1, wherein the requested kernel is a previous kernel different than the single universal kernel, the first sub-kernel of the plurality of sub-kernels is a previous sub-kernel, and the first interaction functionality is a previous functionality corresponding to the previous sub-kernel.

6. The method of claim 1, further comprising determining that the data received from the user device does not comprise a universal kernel tag.

7. The method of claim 1, further comprising receiving, by the access device with a single universal kernel comprising a plurality of interaction functionalities and a plurality of sub-kernels, from a user device, interaction data for processing the interaction in a format compatible with the first interaction functionality.

8. The method of claim 7, further comprising converting the interaction data from a format compatible with the first interaction functionality to a format compatible with a second interaction functionality.

9. The method of claim 1, wherein the data comprising the kernel identifier is received through radio frequency identification (RFID).

10. The method of claim 1, wherein the user device is a mobile electronic device and the data comprising the kernel identifier is received through near field communication (NFC).

11. An access device comprising:
a processor;
a single universal kernel comprising a plurality of interaction functionalities and a plurality of sub-kernels; and
a computer-readable medium coupled to the processor, the computer-readable medium comprising code, executable by the processor, to cause:
receiving, by the access device, from a user device, data comprising a kernel identifier identifying a requested kernel of a plurality of kernels;
determining, by the access device, a first sub-kernel of the plurality of sub-kernels based on the kernel identifier; and
processing, by the access device, an interaction according to a first interaction functionality of the plurality of interaction functionalities corresponding to the first sub-kernel.

12. The access device of claim 11, wherein processing the interaction comprises generating a cryptogram.

13. The access device of claim 11, wherein processing the interaction comprises routing, from the user device to a server device communicatively coupled to the access device, interaction data for the interaction.

14. The access device of claim 13, further comprising code which, when executed by the processor, causes receiving, by the access device, from the server device, an indication to approve the routed interaction.

15. The access device of claim 13, further comprising code which, when executed by the processor, causes receiving, by the access device, from the server device, an indication to deny the routed interaction and responsively terminating the interaction.

16. A method of comprising:
sending, by a user device to an access device with a single universal kernel comprising a plurality of interaction functionalities and a plurality of sub-kernels, data comprising a kernel identifier identifying a requested kernel of a plurality of kernels, wherein the access device determines a first sub-kernel of the plurality of sub-kernels based on the kernel identifier;
responsive to sending the data, receiving by the user device, a request for interaction data; and
sending, by the user device to the access device with the single universal kernel, the interaction data, the interaction data corresponding to a first interaction functionality of the plurality of interaction functionalities corresponding to the first sub-kernel.

17. The method of claim 16, wherein the requested kernel is the single universal kernel, the first sub-kernel of the plurality of sub-kernels is a universal sub-kernel, and the first interaction functionality is a universal functionality corresponding to the universal sub-kernel.

18. The method of claim 16, wherein the requested kernel is a previous kernel different than the single universal kernel, the first sub-kernel of the plurality of sub-kernels is a previous sub-kernel, and the first interaction functionality is a previous functionality corresponding to the previous sub-kernel.

19. The method of claim 16, wherein the interaction data comprises a credential from the user device.

20. The method of claim 16, wherein the user device is in the form of a card.
